(19) United States
(12) Patent Application Publication
(10) Pub. No.: US 2007/0226013 A1
(43) Pub. Date: Sep. 27, 2007

(54) METHOD AND APPARATUS FOR AUTOMATED GENERATION AND TRANSMISSION OF DATA IN A STANDARDIZED MACHINE-READABLE FORMAT

(75) Inventors: Paul Elletson, Stillwater, MN (US); Douglas D. Baird, Edina, MN (US); Timothy M. Dean, Minneapolis, MN (US); Grace Wiechman, Minneapolis, MN (US); Firass Shehadeh, Maple Grove, MN (US); Peter L. Palmer, St. Paul, MN (US)

Correspondence Address: SCHWEGMAN, LUNDBERG, WOESSNER & KLUTH, P.A., P.O. BOX 2938, MINNEAPOLIS, MN, 55402, US

(73) Assignee: CARDIAC PACEMAKERS, INC., NORTH ST. PAUL, MN (US)

(21) Appl. No.: 11/677,789

(22) Filed: Feb. 22, 2007

Related U.S. Application Data
(60) Provisional application No. 60/743,419, filed on Mar. 7, 2006.
(60) Provisional application No. 60/824,999, filed on Sep. 8, 2006.

(51) Int. Cl. G06F 19/00

(52) U.S. Cl. 705/3

(57) ABSTRACT

This document discusses, among other things, systems and methods for generating data in a standardized machine-readable format. A method receives data from one or more patient health monitors at a centralized repository. The method then generates one or more files containing at least a portion of the data and stores the files in a secured web folder. The method then permits access to the files based on one or more security schemes.

### CROSS-REFERENCE TO RELATED PATENT DOCUMENTS

This patent application claims the benefit of priority, under 35 U.S.C. Section 119(e), to Elletson et al., U.S. Provisional Patent Application Ser. No. 60/743,419, entitled “METHOD AND APPARATUS FOR AUTOMATED GENERATION AND TRANSMISSION OF DATA IN A STANDARDIZED MACHINE-READABLE FORMAT,” filed on Mar. 7, 2006 and to Elletson et al., U.S. Provisional Patent Application Ser. No. 60/824,999, entitled “METHOD AND APPARATUS FOR AUTOMATED GENERATION AND TRANSMISSION OF DATA IN A STANDARDIZED MACHINE-READABLE FORMAT,” filed on Sep. 8, 2006, the contents of which are hereby incorporated by reference in their entirety. This application is related to co-pending U.S. patent application Ser. No. ______ (Attorney Docket No. 00279.D62US 1), entitled “METHOD AND APPARATUS FOR AUTOMATED GENERATION AND TRANSMISSION OF DATA IN A STANDARDIZED MACHINE-READABLE FORMAT,” filed on ______.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2007, Cardiac Pacemakers, Inc. All Rights Reserved.

### TECHNICAL FIELD

This patent document pertains generally to implantable medical devices, and more particularly, but not by way of limitation, to systems and methods for automated generation and transmission of data in a standardized machine-readable format.

### OVERVIEW

Example 1 describes a method comprising: receiving data from one or more patient health monitors at a centralized repository; generating one or more files containing at least a portion of the data; storing the one or more files in a secured web folder; and permitting access to the one or more files based on one or more security schemes.

In Example 2, the method of Example 1 is optionally performed such that generating the one or more files occurs automatically in response to a triggering event.

In Example 3, the methods of any one or more of Examples 1 or 2 are optionally performed such that the triggering event includes one or more of a remote follow-up completion, an occurrence of a physiologic event, an occurrence of an alarm detected by at least one of the patient health monitors, detecting that reviewable data has been received by the centralized repository, a scheduled service or task, or uploading a file or data from an external source.

In Example 4, the methods of any one or more of Examples 1-3 are optionally performed comprising: detecting the triggering event; determining a type of triggering event; and using the type of triggering event to affect one or more of a file type, a file format, a file content, a file version, or a file priority of the one or more generated files.

In Example 5, the methods of any one or more of Examples 1-4 are optionally performed such that the one or more files are generated using a standardized format, and wherein the standardized format includes HL7, XML, or ANSI X12.

In Example 6, the methods of any one or more of Examples 1-5 are optionally performed such that the one or more files are generated using one or more of a file type, a file format, a file content, a file version, or a file priority depending on one or more of a recipient's capability or request.

In Example 7, the methods of any one or more of Examples 1-6 are optionally performed such that one or more of the files generated include at least one hypertext link.

In Example 8, the methods of any one or more of Examples 1-7 are optionally performed such that the hypertext link navigates a user to patient-related information.

In Example 9, the methods of any one or more of Examples 1-8 are optionally performed such that the patient-related information includes an electrogram reflecting a heart rhythm prior to, during, and after a cardiac episode, along with event markers or other details on events detected or the therapy provided.

In Example 10, the methods of any one or more of Examples 1-9 are optionally performed such that the secured web folder is provided using WebDAV.

In Example 11, the methods of any one or more of Examples 1-10 are optionally performed such that the security schemes include a certificate-based scheme or a challenge-response scheme.

In Example 12, the methods of any one or more of Examples 1-11 are optionally performed such that the data includes physiological data, environmental data, or patient-related data.

In Example 13, the methods of any one or more of Examples 1-12 are optionally performed such that the received data includes physiological data from a patient health monitor, and wherein the at least a portion of the physiological data was collected by an implanted medical device. Example 13 further comprises: providing an interface to review the received physiological data; detecting a completion of a review of the received physiological data; wherein the generated files are formatted using an HL7 format and generated automatically in response to the detection of the completion of the review; and wherein the one or more files contain at least a portion of the received physiological data, and wherein access to the one or more files is permitted using WebDAV.

In Example 14, the methods of any one or more of Examples 1-13 are optionally performed such that the one or more files are generated including at least one hypertext link that links to detailed information, summary information, or auxiliary information.

In Example 15, the methods of any one or more of Examples 1-14 are optionally performed such that permitting access further includes using a certificate-based scheme or a challenge-response scheme.

In Example 16, the methods of any one or more of Examples 1-15 are optionally performed such that the physiological data includes cardiac data.

In Example 17, the methods of any one or more of Examples 1-16 are optionally performed comprising: detecting a new file in the secured web folder, wherein the new file contains patient-related data and was created by a user of the secured web folder; and importing the patient-related data into the centralized repository.

Example 18 describes a system comprising a patient monitoring device to monitor, collect, and communicate patient physiological data; a server communicatively coupled to the patient monitoring device; a database, communicatively coupled to the server; wherein the server is configured to receive patient physiological data, store the patient physiological database in the database, provide access to review the stored patient physiological data, and upon completion of the review of the stored patient physiological data, generate one or more files in a secured area of the server, wherein the secured area of the server includes a secured web folder.

In Example 19, the system of Example 18 is optionally configured such that the one or more generated files include at least one hypertext link, wherein the hypertext link navigates a user to patient-related information, wherein the patient-related information includes an electrogram reflecting a heart rhythm prior to, during, and after a cardiac episode, along with event markers or other details on events detected or the therapy provided.

In Example 20, the system of any one or more of Examples 18 or 19 are optionally configured such that the generated files are in a standardized format, the standardized format including HL7, XML, or ANSI X12.

In Example 21, the system of any one or more of Examples 18-20 are optionally configured such that access to the secured web folder is provided using WebDAV.

Example 22 describes a computer-readable medium including instructions that, when performed by a computer, cause the computer to: receive data from one or more patient health monitors at a centralized repository; generate one or more files containing at least a portion of the data; store the one or more files in a secured web folder; and permit access to the one or more files based on one or more security schemes.

In Example 23, the computer-readable medium of Example 22 optionally includes instructions such that the generating the one or more files occurs automatically in response to a triggering event, further wherein the triggering event includes one or more of a remote follow-up completion, an occurrence of a physiologic event, an occurrence of an alarm detected by at least one of the patient health monitors, detecting that reviewable data has been received by the centralized repository, a scheduled service or task, or uploading a file or data from an external source.

In Example 24, the computer-readable medium of any one or more of Examples 22 or 23 optionally includes instructions that cause the computer to: detect the triggering event; determine a type of triggering event; and use the type of triggering event to affect one or more of a file type, a file format, a file content, a file version, or a file priority of the one or more generated files.

In Example 25, the computer-readable medium of any one or more of Examples 22-24 optionally includes instructions such that the one or more files are generated using a standardized format, and wherein the standardized format includes HL7, XML, or ANSI X12.

In Example 26, the computer-readable medium of any one or more of Examples 22-25 optionally includes instructions that cause the computer to: detect a new file in the secured web folder, wherein the new file contains patient-related data and was created by a user of the secured web folder; and import the patient-related data into the centralized repository.

### BACKGROUND

Implantable medical devices (IMDs), including cardiac rhythm management devices such as pacemakers and implantable cardioverter/defibrillators, typically have the capability to communicate with an external device, such as an external programmer, via wireless telemetry, such as a radio-frequency (RF) or other telemetry link. While an external programmer is typically provided to program and modify the operating parameters of an IMD, modem IMDs also include the capability for bidirectional communication so that information, such as physiological data, can be transmitted to the programmer. Home health care remote monitoring systems can also communicate with the IMD and collect the patient and patient-related data. In addition, some monitoring systems can also collect other objective or subjective data using additional external sensors, such as a blood pressure cuff, a weight scale, or a specialized device that prompts the patient with questions regarding their health state. Home health care monitoring systems can communicate with a centralized system, either directly or through a networked system. Centralized systems, including medical practice systems, provide an efficient mode for physicians and other medical practitioners to view patient-related data.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic view of a system that automatically generates and transmits data in a standardized machine-readable format.

FIG. 2 is a dataflow diagram illustrating an example of automatic data retrieval.

FIG. 3 is a flowchart of a method that automatically obtains and provides data in a standardized machine-readable format.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### EXAMPLES

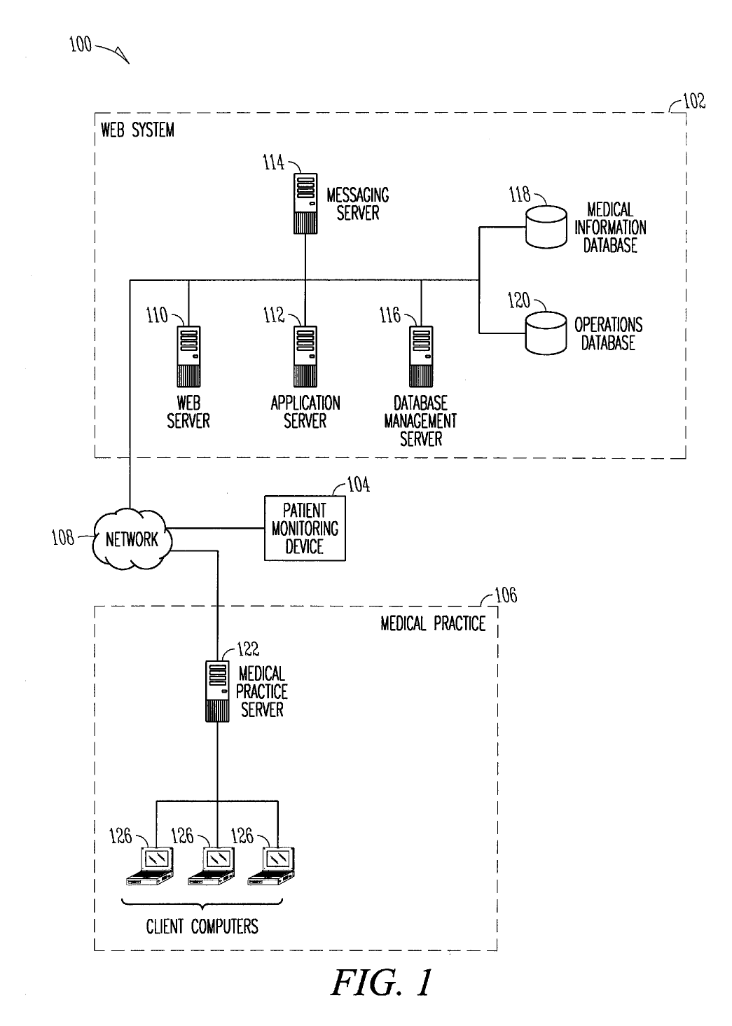

FIG. 1 is a schematic view of a system 100 that automatically generates and transmits data in a standardized machine-readable format. The system 100 includes a web system 102, a patient monitoring device 104, and one or more medical practice systems 106, all communicatively coupled via a network 108. In an example, the web system 102 includes a web server 110, an application server 112, a messaging server 114, and a database management server 116, which is used to manage at least a medical information database 118 and an operations database 120. In an example, the medical practice system includes a medical practice server 122, and one or more client computers 126.

The patient monitoring device 104 includes one or more implantable or external devices that monitor a patient to collect, analyze, or communicate patient physiological data, environmental data, or other patient-related data in various examples. In example, the patient monitoring device 104 may include one or more implanted medical device (IMD), such as an implantable cardiac rhythm management device, an external physiological sensor (e.g., a blood pressure cuff) or an external environmental sensor (e.g., a humidity sensor). In another example, the patient monitoring device 104 includes a communicator device that aggregates patient-related data, such as physiological data or interrogatory data, and communicates such data to the web system 102.

Medical information database 118 may include data such as patient identification information; patient treatment history; patient physiological data in raw, processed, or summarized format; physician or clinician notes or orders; sensor data; and the like. The medical information database 118 may be implemented as a relational database, a centralized database, a distributed database, an object oriented database, or a flat database in various examples.

Operations database 120 may include data such as user login information (e.g., usernames and passwords), access groups, operations logs, error reports, and the like. The operations database 120 may be implemented as a relational database, a centralized database, a distributed database, an object oriented database, or a flat database in various examples.

In an example, data from the patient monitoring device 104 is uploaded to the web system 102 via the network 108. The data may be stored in the medical information database 118. A user (not shown) may review the data, such as via the web server 110. After the review, one or more files are automatically generated. In an example, files are generated using an application, script, servlet, or library file that is executed from the application server 112. Files may be stored in the medical information database 118, the operations database 120, the web server 110, or at another location, such as a dedicated file server (not shown). In an example, after the files are created and stored, the messaging server 114 is used to send a message notification to one or more medical practice users notifying them of the newly created files, such as via email, pager, text messaging, or the like.

At some time, the medical practice server 122 may connect to the web system 102 to retrieve the newly generated files. Using a client computer 126, a medical practice user can connect to the medical practice server 122 and view or modify the file. In an example, the medical practice server 122 imports the retrieved data into a medical practice's EMR system (not shown), which the medical practice user may access to view and manage the data. In an example, the file includes one or more hyperlinks that permit the user to retrieve additional information. In an example, the hyperlinks direct the user's browser to information stored in the web system 102. Information may include patient-related information, such as an electrogram reflecting the heart rhythm prior to, during, and after a cardiac episode, along with event markers or other details on events detected or the therapy provided.

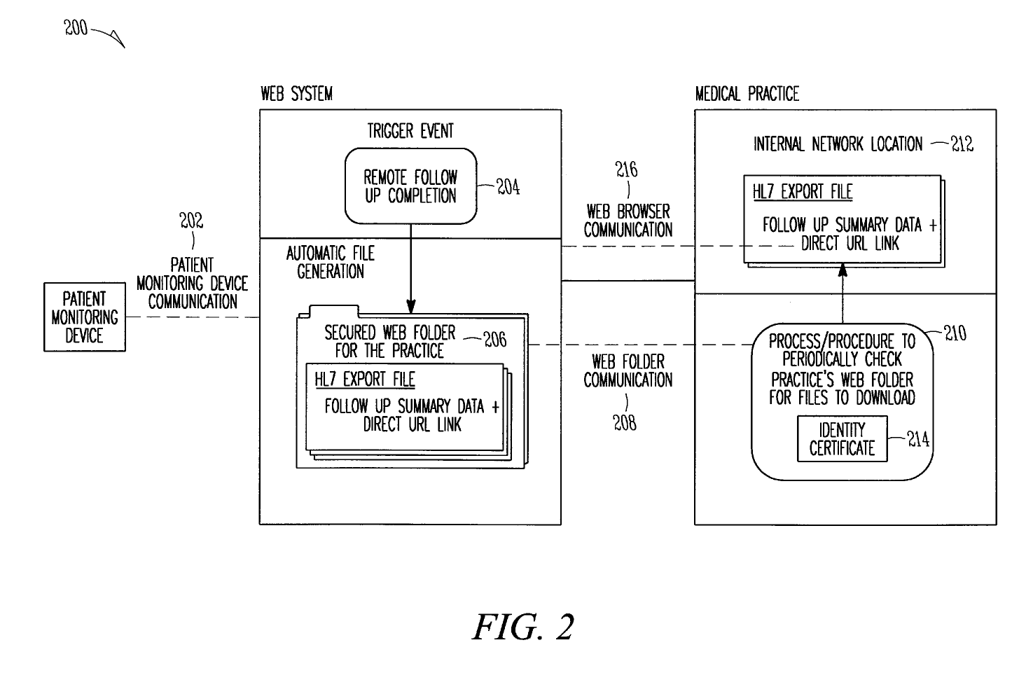

FIG. 2 is a dataflow diagram 200 illustrating an example of automatic data retrieval. In an example, at 202, an implantable medical device (IMD) interrogation is automatically uploaded from a patient's monitoring device to a web system. This is generally automatically initiated by patient monitoring devices, which connect to the web system 102 to upload data. In other examples, the web system 102 automatically polls patient monitoring devices periodically or regularly, and can request data uploads.

At 204, a triggering event is detected and a file is automatically generated and made available for access by being placed in a secured web folder 206. Triggering events include occurrence of a physiologic event or alarm detected at the IMD, remote follow-up completion (e.g., completion of a inspection or review of IMD or external sensor data by a physician or clinician), sensing that reviewable data has been received from a patient monitor device, uploading a file or data from a removable medium (e.g., a CD-ROM, floppy disk, or flash drive) where the file could include data from a previously completed follow-up, a demographic update in the web system (e.g., medical information database 118 at FIG. 1), uploading data from a patient's monitoring device, or a scheduled service or task, in various examples.

At 208, a process or procedure 210 communicates with the secured web folder 206 and checks for new files and, upon detection, downloads them to a location 212 on the medical practice's network. In various examples, the secured web folder 206 is checked regularly, recurrently, in response to a user command, or otherwise scheduled or activated. In some examples, one or more secured web folders 206 are associated or assigned to a medical practice, which may advantageously provide increased security. In other examples, a single secured web folder 206 may provide additional security means, such as file-level password protection, encryption, access security (e.g., ownership), or the like.

To access a secured web folder 206, the medical practice system presents a valid public key certificate, henceforth called an identity certificate. The identity certificate provides a certificate-based mutually authenticated security means. Access is granted when the identity certificate 214 is authenticated by the web system. The secured web folder 206 contains a data set of patient-related data, including a URL (Uniform Resource Locator) link or other hypertext link that the medical practice may use 216 to obtain additional data from the web system on a particular patient whose data is in the data set.

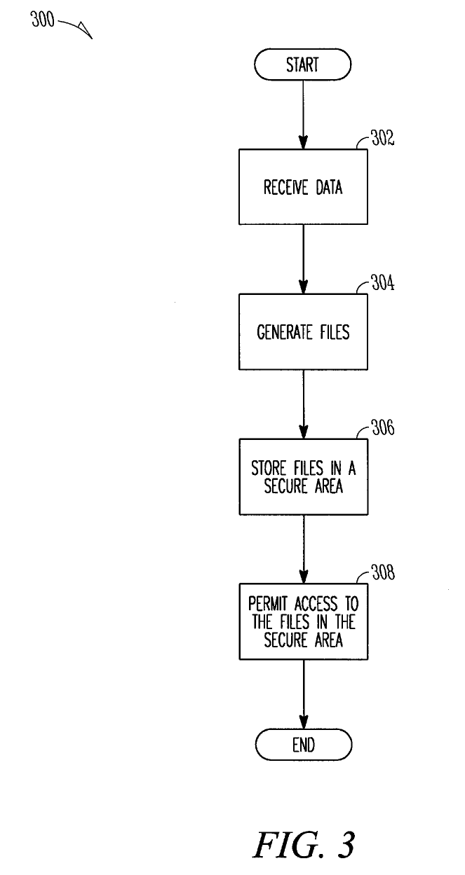

FIG. 3 is a flowchart of a method 300 that automatically obtains and provides data in a standardized machine-readable format. At 302, data from one or more patient monitoring devices is received at a centralized repository. As described with reference to FIG. 1, patient monitoring devices can include one or more implantable or external devices that monitor a patient to collect, analyze, or communicate patient physiological data, environmental data, or other patient-related data. A patient monitoring device may collect or receive data from one or more sensors, such as an implantable medical device or a surface EKG monitor, to be communicated to the centralized repository (e.g., a web system 102).

At 304, one or more files are generated after a triggering event. In certain examples, one or more events can be sensed to trigger the file generation. Examples of triggering events include, but are not limited to, occurrence of a physiologic event or alarm detected at the IMD, remote follow-up completion (e.g., completion of a inspection or review of IMD or external sensor data by a physician or clinician), sensing that reviewable data has been received, uploading a file or data from a removable medium (e.g., a CD-ROM, floppy disk, or flash drive) where the file could include data from a previously completed follow-up, a demographic update, uploading data from a patient's monitoring device 104, or a scheduled service or task. In further examples, two or more files are generated during the automatic creation procedure.

In an example, a medical practice system 106 can perform a remote follow-up of an implantable medical device (IMD) using a browser-based access to an externally hosted web system to which an IMD interrogation has been uploaded from the patient's monitoring device 104. For example, the remote follow-up may include a physician or clinician reviewing IND interrogation data, analyzing summary data, providing comments or annotations, or the like. In an example, the completion of the remote follow-up acts as a triggering event to automatically generate a file of machine-readable data and place it in a location that is accessible by the medical practice system 106.

In certain examples, the automatically created file is provided in a standardized format. Examples of standardized file formats include, without limitation, XML, Health Level 7 (HL7), or ANSI X12. In one example, an HL7 file is structured according to the HL7 version 2.3.1 Observation Result Unsolicited (ORU) message type, which provides for the transmission of observation information about a patient. In a further example, the downloaded file contains one or more message types other than HL7 ORU messages, such as an HL7 Admission, Discharge, and Transfer (ADT) message. In certain examples, the type of triggering event determines the type of message created or one or more other aspects of the message, such as content, format, or priority. In some examples, the needs, requirements, or capabilities of the medical practice determine the message type, format, content, or priority. For example, if a medical practice's electronic medical records (EMR) system uses an HL7 message type, then the web system 102 can create or translate the file in HL7 format to accommodate that particular EMR system. In an example, the message format is dynamically configured using at least a portion of a request by a medical practice system 106. In other examples, the preferred format of a medical practice system 106 is stored and maintained in the web system 102, such as in a table in the operations database 120. When a file is created and stored for a medical practice in the secured web folder, a database table can be queried to determine the preferred file format.

Each file can include information, such as device settings or other values from the last IMD interrogation by the patient's monitoring device. Each file can include other information, such as historical data, graphical data, information on the leads connected to a patient's IMD, or external sensor data. In an example, the export file can contain information that existed in the web system at the time the remote follow-up was completed.

In some examples, generated files may be provided in one or more versions. For example, as the web system 102 evolves and more data or different views (e.g., summary data, trend data, or other calculated data supersets or subsets) become available, progressive versions of the generated file may be offered to one or more medical practices.

In an example, a web browser or other administrative user interface is provided to medical practice users, such as to control one or more aspects of the file generation and communication, such as the file type, format, content, priority, or version to generate. In an example, medical practice users may also control other aspects of the communication, such as enabling or disabling the service, controlling notification messages (e.g., enabling or disabling notification, method of notification, frequency, types of messages that trigger notification), or controlling authentication or security information. In an example, a customer service representative may access an administrative user interface to make changes to a medical practice's settings on behalf of the medical practice.

In an example, upon completion of a remote follow-up, the web system 102 can generate an HL7 export file of follow-up summary data, place it in a medical practice's secured web folder, and track the export file's transfer status, including when the medical practice has retrieved it. For example, an acknowledgement may be provided by the medical practice after a data file in the secured web folder has been accessed or retrieved. Acknowledgements may be implemented in various ways by the medical practice, such as by placing an acknowledgement file in the secured web folder. In another example, the mere access or retrieval of a data file may signal an acknowledgement. In a further example, the web system 102 tracks the file transfer status to the point where the medical practice has not only retrieved it, but also processed it, e.g., imported it in to its EMR system.

At 306, the files are placed in a secure area, such as a secure web folder. In certain examples, the location is provided using a web system 102 that hosts a particular secured web folder for the particular medical practice, such as by using the WebDAV protocol. For example, each practice can have a single secured web folder with access secured using a certificate-based mutually authenticated secure sockets layer (SSL). In a further example, the medical practice can have a persistent connection to the location hosting the secured web folder and can access the machine-readable data immediately after creation at, or transfer to, the secure area.

In other examples, web systems may implement the WebDAV protocol in one or more other ways. In one example, the web system 102 may implement the WebDAV protocol on one or more web servers, making physical folders on the web servers accessible through each server's built-in WebDAV support. In another example, the web system 102 includes one or more application servers (e.g., application server 112), which provide WebDAV support such as via a WebDAV servlet or a Java library. In an example, the Java library includes Slide by the Jakarta project. One version of Slide includes support for maintaining files on the web system in various forms (e.g., database, version control system, data broker, physical folders, etc.) such that the files can be served transparently through the protocol.

In some examples, the medical practice system 106 can implement a process or procedure (e.g., software) that uses a WebDAV protocol and periodically or regularly checks a web folder for the appearance of a newly-generated file. If the process detects one or more new files, then the process can download them to a location, such as on the practice's network. This can provide the practice timely access to the data for later use, such as for importing the data into its in-house system (e.g., an electronic medical records (EMR) system, clinical notes repository, etc.).

In other examples, the web system 102 provides one or more automatic notifications to each practice when new files relevant to that practice are available (such as via the messaging server 114); removing the practice's need to regularly check its web folder for new files. In one example, the web system 102 notifies a medical practice system 106 of new files using a messaging mechanism that triggers a client-side (e.g., at the medical practice) process to check its associated web folder and retrieve any new files.

At 308, the method 300 permits access to the data in the secure area based on one or more security schemes. In an example using a web folder, in order for the practice to connect to its corresponding web folder, the practice presents a valid identity certificate that has been issued by a trusted certificate authority (e.g., VeriSign) and approved by the organization that controls access. Using a security mechanism as described allows the practice to securely access the externally hosted web folder, and the private patient-related data contained therein. In other examples, one or more security systems are used. For example, a challenge-response system can be used, such as where each medical practice is assigned a username and password to access its assigned secured web folder.

In some examples, a practice can retrieve further detail than what was included in the downloaded file, such as by using a URL link. The URL link may be included in the downloaded file and may provide the user with further or more detailed patient-related information that resides in an externally hosted web system (e.g., the web system 102). In certain examples, the downloaded file includes summary information, such as a high-level count of cardiac arrhythmia episodes for the patient (e.g., atrial fibrillation, ventricular tachyarrhythmia, etc.). By following a URL link, for example, a user can access the web system 102 and explore further detail, such as in the form of an electrogram reflecting the heart rhythm prior to, during, and after each episode, along with event markers or other details on events detected or the therapy provided by the patient's IMD.

In another example, the summary information contained in the downloaded file may include high-level descriptions of device-related alerts, such as a warning that the IMD's battery is past its early replacement indicator and the web system 102 can provide further detail on the battery status, such as the projected amount of energy remaining.

In a further example, the summary information includes high-level descriptions of implantable or external sensor-related alerts, such as a warning that the patient has recently experienced excessive weight gain or loss. For example, in a heart failure patient, weight gain can signify fluid retention that accompanies pulmonary edema, which may be a precursor to decompensation requiring hospitalization. In such an example, a user can access the web system 102 to view detailed information on the patient's health, such as heart rate variability plots or other heart failure status or other diagnostic information.

In another example, the summary information includes the results of the most recent lead tests for the leads connected to the patient's MD. Detailed information at the web system 102 comprises the results of the IMD's daily diagnostic lead tests, which can be used to calculate trend data.

In certain examples, a practice can write data or files directly or indirectly to the web folder to be imported into the web system 102. Data or files written to the web folder may include demographic updates, lab results, or the like. The web system 102 can then import the data into a storage device, for example, a database (e.g., medical information database 118). Centralized data is advantageous for patients who see several health care providers, where not every health care provider is a member of the same medical practice and thus, does not have access to each other's EMR database.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. For example, although the description describes a particular example in which information is provided to a medical practice, in other examples, one or more other users obtain such information using the present systems and methods. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

For the purposes of this specification, the term “machine-readable medium” or “computer-readable medium” shall be taken to include any medium which is capable of storing or encoding a sequence of instructions for execution by the machine and that cause the machine to perform any one of the methodologies of the inventive subject matter. The terms “machine-readable medium” or “computer-readable medium” shall accordingly be taken to include, but not be limited to, solid-state memories, optical and magnetic disks, and other temporary, transient, or permanent storage means, such an executable streaming downloadable program. Further, it will be appreciated that the software could be distributed across multiple machines or storage media, which may include the machine-readable medium.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A method comprising:
receiving data from one or more patient health monitors at a centralized repository;
generating one or more files containing at least a portion of the data;
storing the one or more files in a secured web folder; and
permitting access to the one or more files based on one or more security schemes.

2. The method of claim 1, wherein the generating the one or more files occurs automatically in response to a triggering event.

3. The method of claim 2, wherein the triggering event includes one or more of a remote follow-up completion, an occurrence of a physiologic event, an occurrence of an alarm detected by at least one of the patient health monitors, detecting that reviewable data has been received by the centralized repository, a scheduled service or task, or uploading a file or data from an external source.

4. The method of claim 3, comprising:
detecting the triggering event;
determining a type of triggering event; and
using the type of triggering event to affect one or more of a file type, a file format, a file content, a file version, or a file priority of the one or more generated files.

5. The method of claim 1, wherein the one or more files are generated using a standardized format, and wherein the standardized format includes HL7, XML, or ANSI X12.

6. The method of claim 1, wherein the one or more files are generated using one or more of a file type, a file format, a file content, a file version, or a file priority depending on one or more of a recipient's capability or request.

7. The method of claim 1, wherein one or more of the files generated include at least one hypertext link.

8. The method of claim 7, wherein the hypertext link navigates a user to patient-related information.

9. The method of claim 8, wherein the patient-related information includes an electrogram reflecting a heart rhythm prior to, during, and after a cardiac episode, along with event markers or other details on events detected or the therapy provided.

10. The method of claim 1, wherein the secured web folder is provided using WebDAV.

11. The method of claim 1, wherein the security schemes include a certificate-based scheme or a challenge-response scheme.

12. The method of claim 1, wherein the data includes physiological data, environmental data, or patient-related data.

13. The method of claim 1, wherein the received data includes physiological data from a patient health monitor, and wherein the at least a portion of the physiological data was collected by an implanted medical device; and comprising:
providing an interface to review the received physiological data;
detecting a completion of a review of the received physiological data;
wherein the generated files are formatted using an HL7 format and generated automatically in response to the detection of the completion of the review; and wherein the one or more files contain at least a portion of the received physiological data, and wherein access to the one or more files is permitted using WebDAV.

14. The method of claim 13, wherein the one or more files are generated including at least one hypertext link that links to detailed information, summary information, or auxiliary information.

15. The method of claim 13, wherein permitting access further includes using a certificate-based scheme or a challenge-response scheme.

16. The method of claim 13, wherein the physiological data includes cardiac data.

17. The method of claim 1, comprising:
detecting a new file in the secured web folder, wherein the new file contains patient-related data and was created by a user of the secured web folder; and
importing the patient-related data into the centralized repository.

18. A system comprising:
a patient monitoring device to monitor, collect, and communicate patient physiological data;
a server communicatively coupled to the patient monitoring device;
a database, communicatively coupled to the server;
wherein the server is configured to receive patient physiological data, store the patient physiological database in the database, provide access to review the stored patient physiological data, and upon completion of the review of the stored patient physiological data, generate one or more files in a secured area of the server, wherein the secured area of the server includes a secured web folder.

19. The system of claim 18, wherein the one or more generated files include at least one hypertext link, wherein the hypertext link navigates a user to patient-related information, wherein the patient-related information includes an electrogram reflecting a heart rhythm prior to, during, and after a cardiac episode, along with event markers or other details on events detected or the therapy provided.

20. The system of claim 18, wherein the generated files are in a standardized format, the standardized format including HL7, XML, or ANSI X12.

21. The system of claim 18, wherein access to the secured web folder is provided using WebDAV.

22. A computer-readable medium including instructions that, when performed by a computer, cause the computer to:
receive data from one or more patient health monitors at a centralized repository;
generate one or more files containing at least a portion of the data;
store the one or more files in a secured web folder; and
permit access to the one or more files based on one or more security schemes.

23. The computer-readable medium of claim 22, wherein the generating the one or more files occurs automatically in response to a triggering event, further wherein the triggering event includes one or more of a remote follow-up completion, an occurrence of a physiologic event, an occurrence of an alarm detected by at least one of the patient health monitors, detecting that reviewable data has been received by the centralized repository, a scheduled service or task, or uploading a file or data from an external source.

24. The computer-readable medium of claim 23, comprising instructions that cause the computer to:
detect the triggering event;
determine a type of triggering event; and
use the type of triggering event to affect one or more of a file type, a file format, a file content, a file version, or a file priority of the one or more generated files.

25. The computer-readable medium of claim 22, wherein the one or more files are generated using a standardized format, and wherein the standardized format includes HL7, XML, or ANSI X12.

26. The computer-readable medium of claim 22, comprising instructions that cause the computer to:
detect a new file in the secured web folder, wherein the new file contains patient-related data and was created by a user of the secured web folder; and
import the patient-related data into the centralized repository.
